(19) United States
(12) Patent Application Publication
(10) Pub. No.: US 2014/0181869 A1
(43) Pub. Date: Jun. 26, 2014

(54) ELECTRONIC DEVICE AND METHOD OF CONTROLLING ELECTRONIC DEVICE

(71) Applicant: KABUSHIKI KAISHA TOSHIBA, Tokyo (JP)

(72) Inventor: Joji Yamashita, Hachioji-shi (JP)

(73) Assignee: KABUSHIKI KAISHA TOSHIBA, Tokyo (JP)

(21) Appl. No.: 14/013,713

(22) Filed: Aug. 29, 2013

Related U.S. Application Data
(63) Continuation of application No. PCT/JP2013/059067, filed on Mar. 27, 2013.

(30) Foreign Application Priority Data
Dec. 21, 2012 (JP) 2012-280166

(51) Int. Cl. H04N 21/482; H04N 21/422

(52) U.S. Cl. CPC H04N 21/482; H04N 21/42204
USPC 725/39

(57) ABSTRACT

According to one embodiment, an electronic device of one embodiment is provided with a voice call function for performing a voice call with an external device via a network. The device comprises a reproducer and a controller. The reproducer receives a broadcast signal to reproduce a program contained in the broadcast signal. The controller is configured to turn off the voice call function within a preset period of time. The preset period of time covers the time when the reproducer should start to reproduce a preset program.

### CROSS REFERENCE TO RELATED APPLICATIONS

This application is a Continuation application of PCT Application No. PCT/JP2013/059067, filed Mar. 27, 2013 and based upon and claiming the benefit of priority from Japanese Patent Application No. 2012-280166, filed Dec. 21, 2012, the entire contents of all of which are incorporated herein by reference.

### FIELD

Embodiments described herein relate generally to an electronic device and a method of controlling the electronic device.

### BACKGROUND

Conventionally, an electronic device such as a broadcast receiving device configured to receive a broadcast signal and reproduce a video content such as a program included in the received broadcast signal has been generally available. In addition, an electronic device comprising a communication module connected to a network and having a function capable of accessing an address on the network has been generally available. Furthermore, an electronic device comprising a voice call function using communication via a network has been generally available.

In the conventional device, there is no means for associating a function of switching between validation and invalidation of the voice call function with a predetermined program or channel. However, when a user watches the specific program or channel, there is a demand to invalidate the voice call function.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram illustrating an electronic device according to an embodiment.

FIG. 2 is a diagram illustrating the electronic device according to the embodiment.

FIG. 3 is a diagram illustrating the electronic device according to the embodiment.

FIG. 4 is a diagram illustrating the electronic device according to the embodiment.

FIG. 5 is a diagram illustrating the electronic device according to the embodiment.

FIG. 6 is a diagram illustrating the electronic device according to the embodiment.

FIG. 7 is a diagram illustrating the electronic device according to the embodiment.

FIG. 8 is a diagram illustrating the electronic device according to the embodiment.

FIG. 9 is a diagram illustrating the electronic device according to the embodiment.

### DETAILED DESCRIPTION

Disclosed are embodiments relating to an electronic device offering high convenience and a method of controlling the electronic device.

In general, according to one embodiment, there is provided an electronic device having a voice call function for performing a voice call with an external device via a network. The reproducer receives a broadcast signal to reproduce a program contained in the broadcast signal. The controller is configured to turn off the voice call function within a preset period of time. The preset period of time covers the time when the reproducer should start to reproduce a preset program.

Hereinafter, an electronic device and a method of controlling the electronic device according to an embodiment will be described in detail with reference to the drawings.

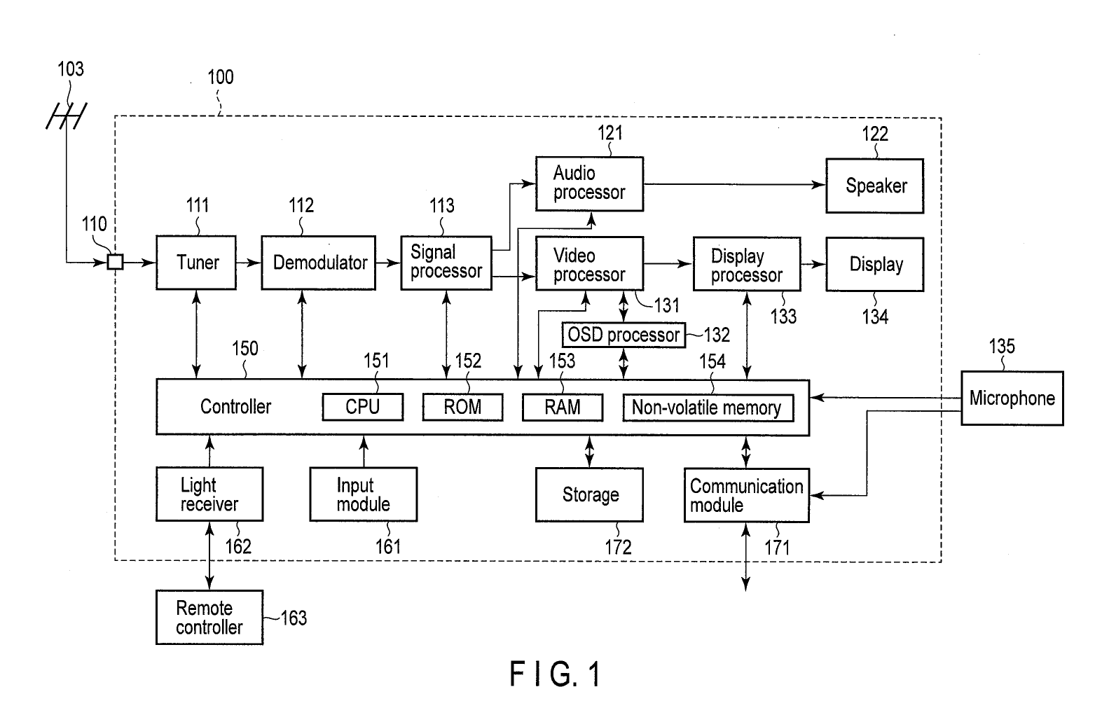

FIG. 1 illustrates an example of a broadcast receiving device 100 according to an embodiment.

The broadcast receiving device 100 is an electronic device configured to reproduce, for example, a broadcast signal or a video content stored in a storage medium. The broadcast receiving device 100 may be an electronic device such as a television, a recorder, a PC (Personal Computer) comprising a tuner, or a mobile phone terminal such as a mobile phone comprising a tuner. The broadcast receiving device 100 can be connected to a network through a wireless communication terminal serving as a wireless communication access point.

The broadcast receiving device 100 comprises a broadcast signal input terminal 110, a tuner 111, a demodulator 112, a signal processor 113, an audio processor 121, a video processor 131, an OSD processor 132, a display processor 133, a controller 150, an input module 161, a light receiver 162, a communication module 171, and a storage 172. The broadcast receiving device 100 further comprises a speaker 122 and a display 134.

The broadcast signal input terminal 110 can receive, for example, a digital broadcast signal received by an antenna 103. The antenna 103 can receive, for example, a terrestrial digital broadcast signal, a BS (Broadcasting Satellite) digital broadcast signal, and/or a 110-degrees CS (Communication Satellite) digital broadcast signal. The broadcast signal input terminal 110 can receive content data such as a program supplied by the digital broadcast signal.

The broadcast signal input terminal 110 supplies the received digital broadcast signal to the tuner 111. The tuner 111 may be a tuner for a digital broadcast signal. The tuner 111 transmits the tuned digital broadcast signal to the demodulator 112.

The demodulator 112 demodulates the received digital broadcast signal. Thus, the demodulator 112 acquires content data such as a transport stream (TS) from the digital broadcast signal. The demodulator 112 inputs the acquired content data to the signal processor 113. That is, the antenna 103, the tuner 111 and the demodulator 112 serve as a receiver configured to receive the content data.

The signal processor 113 performs signal processing such as separation of the content data.

That is, the signal processor 113 separates the content data into a digital video signal, a digital audio signal, and other data signals. The signal processor 113 supplies the audio signal to the audio processor 121. In addition, the signal processor 113 supplies the video signal to the video processor 131. The signal processor 113 supplies the data signals to the controller 150.

The audio processor 121 converts the digital audio signal received from the signal processor 113 to a signal (audio signal) in a format capable of being reproduced by the speaker 122. For example, the audio processor 121 converts the digital audio signal to the audio signal through digital-to-analog conversion. The audio processor 121 supplies the audio signal to the speaker 122. The speaker 122 reproduces sound based on the supplied audio signal.

The video processor 131 converts the digital video signal received from the signal processor 113 to a video signal (video signal for display) in a format capable of being reproduced on the display 134. The video processor 131 performs rendering to generate the video signal for display based on the digital video signal supplied from the signal processor 113. The video processor 131 performs the rendering by performing various calculation processes on the digital video signal supplied from the signal processor 113. The video processor 131 outputs the rendered video signal for display to the display processor 133.

The OSD processor 132 generates the video signal for display for displaying a variety of information such as a menu screen, a Web browser, various application windows or menus on the display 134 in response to a command supplied from the controller 150. The OSD processor 132 superimposes the generated video signal for display on the video signal for display output from the video processor 131.

The display processor 133 adjusts image quality, such as tone, brightness, sharpness, or contrast, of the received video signal under the control of the controller 150. The display processor 133 supplies the video signal for display after the image quality has been adjusted to the display 134. The display 134 displays video based on the supplied video signal for display.

The display 134 comprises a liquid crystal display device comprising a liquid display panel comprising a plurality of pixels arranged in a matrix and a backlight illuminating the liquid crystal panel. The display 134 displays the video based on the video signal for display supplied from the display processor 133.

The controller 150 is a controller configured to control operations of the respective components of the broadcast receiving device 100. The controller 150 comprises a CPU 151, a ROM 152, a RAM 153, and a non-volatile memory 154. The controller 150 performs various processes based on signals supplied from the light receiver 162 or the input module 161.

The CPU 151 comprises a calculating element configured to execute various calculation processes. The CPU 151 implements various functions by executing programs stored in the ROM 152 or the non-volatile memory 154.

The ROM 152 stores a program for controlling the broadcast receiving device 100 and a program for implementing various functions. The CPU 151 activates the programs stored in the ROM 152 based on the signal supplied from the input module 161. In such a configuration, the controller 150 controls the operations of the respective components.

The RAM 153 functions as a working memory of the CPU 151. That is, the RAM 153 stores data read by the CPU 151 as a calculation result of the CPU 151.

The non-volatile memory 154 is a non-volatile memory storing various setting information and programs.

Furthermore, the controller 150 generates commands for displaying various user interfaces on the display 134. The controller 150 supplies the generated commands to the OSD processor 132. Thus, the controller 150 can control the OSD processor 132 to generate the user interface superimposed on the video.

The input module 161 comprises, for example, keys that generate signals in response to inputs by a user, or a touchpad. Furthermore, the input module 161 may be configured to receive signals from a keyboard, a mouse, or other input devices that can generate signals. The input module 161 supplies the signals to the controller 150. The touchpad includes a capacitive sensor, or devices that generate positional information based on other manners.

The light receiver 162 comprises a light receiving lens for receiving infrared rays from a remote controller 163 and a sensor such as a photodiode for converting the received light into an electrical signal. The light receiver 162 generates an original signal from the received infrared ray and supplies the signal to the controller 150.

The remote controller 163 generates the signal based on the input of the user. The remote controller 163 converts the generated signal into the infrared ray and outputs the infrared ray. Thus, the remote controller 163 transmits the infrared ray to the light receiver 162.

The communication module 171 can communicate with other devices on the Internet or a network such as a home network through a wireless communication terminal using a LAN or a wireless LAN. Thus, the broadcast receiving device 100 can communicate other devices connected to the wireless communication terminal.

The storage 172 comprises a hard disk drive (HDD), a solid-state drive (SSD), or other storage devices. The controller 150 can store the transport steam processed by the signal processor 113 in the storage 172. Moreover, the controller 150 can encode the transport stream to data in another format. The controller 150 may store the encoded data in the storage 172. Thus, the broadcast receiving device 100 can record the broadcast signal or the content supplied via the network in the storage 172.

The broadcast receiving device 100 may comprise a plurality of tuners 111 and demodulators 112. When the plurality of tuners 111 and demodulators 112 are provided, the broadcast receiving device 100 can acquire a signal of a plurality of frequencies from the broadcast signal. Thus, the broadcast receiving device 100 can simultaneously acquire a transport stream of a plurality of channels. Accordingly, the broadcast receiving device 100 can simultaneously record the transport stream of multiple channels or the encoded data of the transport stream in the storage 172.

In addition, the broadcast receiving device 100 comprises a terminal connected to a microphone 135. The microphone 135 is a sound collecting device configured to convert sound into an electrical signal (audio signal). The controller 150 can receive the audio signal supplied from the microphone 135 through the terminal.

Furthermore, the communication module 171 may receive signals from the keyboard, the mouse, the microphone 135, a headset or other input devices. For example, when the broadcast receiving device 100 comprises a USB terminal or a module of Bluetooth (registered trademark), the communication module 171 receives the signal from the input device connected through the USB or the Bluetooth and supplies the signal to the controller 150.

In addition, the storage 172 stores applications (software) capable of executing various processes. For example, the storage 172 stores a voice call application (voice call function) capable of transmitting and receiving the audio signal to and from another device via the network.

When executing the voice call function, the broadcast receiving device 100 can transmit the audio signal supplied from the microphone 135 to another device via the network. In addition, when executing the voice call function, the broadcast receiving device 100 can output the audio signal supplied from another device via the network through the speaker 122 or the headset connected to the communication module 171. Thus, the broadcast receiving device 100 can perform a voice call with another device via the network.

The controller 150 executes the voice call function at the time of activating the broadcast receiving device 100 or based on the input. Moreover, the controller 150 can execute the voice call function as a background.

The controller 150 can turn on or off the voice call function, based on the input, a status of the broadcast receiving device 100, or a preset condition. For example, when the voice call function is a function of logging in an authenticated server by using an ID and a password and connecting a user to another user through the server, the controller 150 can turn off the voice call function by logging out of the authenticated server. Furthermore, the controller 150 can turn off the voice call function by stopping (that is, invalidating) the application software of the voice call function.

The controller 150 selects the broadcast signal in response to the input. Namely, the controller 150 selects a program (or a channel for presenting a program) displayed by the broadcast receiving device 100 in response to the input.

In addition, the controller 150 acquires information for generating an electronic program guide (EPG) from the broadcast signal. For example, the controller 150 can acquire information on channels (channel information) and information on each program (program information) of each channel. The program information includes information indicating a broadcasting station, information indicating a broadcasting time, information indicating a genre of a program, information indicating a summary of a program (program summary), and information indicating a detail of a program (program detail information).

By acquiring the channel information and the program information, the controller 150 can recognize a list of channels and a list of programs included in the broadcast signal. That is, the controller 150 serves as a screen generator that generates an EPG screen based on the acquired information. The controller 150 stores the generated EPG screen in the RAM 153 or the non-volatile memory 154. In addition, the controller 150 and the OSD processor 132 can display the EPG screen stored in the RAM 153 or the non-volatile memory 154 on the display 134 in response to the input.

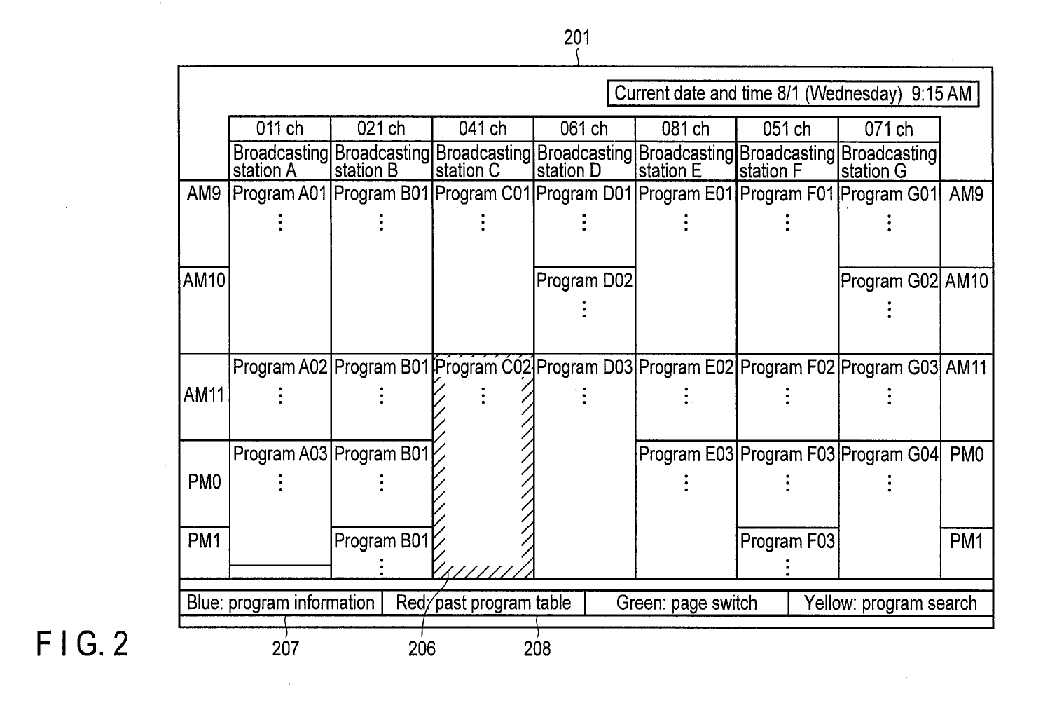

FIG. 2 illustrates an example of an EPG screen 201. The EPG screen 201 is a kind of GUI (Graphical User Interface). The controller 150 can cause the OSD processor 132 to render various screens of the GUI.

The GUI includes an electronic program guide, a program information display, and various menus, which are graphically displayed on the display 134. The controller 150 can notify a user of a variety of information by controlling the OSD processor 132 in order to display the GUI on the display 134.

The EPG screen 201 includes a list of programs for each channel broadcasted at every time slot. The controller 150 transversely displays a list of channels. Moreover, the controller 150 longitudinally displays a list of programs for each channel. Furthermore, the controller 150 may display the program information in program sections.

The controller 150 selects one section from among a plurality of program sections displayed on the EPG screen 201 in response to the input. In the example illustrated in FIG. 2, a program section 206 of a program of “041ch” starting at 11:00 a.m. is selected.

In this case, the broadcast receiving device 100 executes various processes in response to the input such as a color key or a decision key of the remote controller 163.

In addition, the EPG screen 201 includes guiding indications 207 and 208. The guiding indication 207 is an indication for giving the user the notification that the program information is displayed when a blue color key is selected. The guiding indication 208 is an indication for giving the user the notification that a past program table is displayed when a red color key is selected.

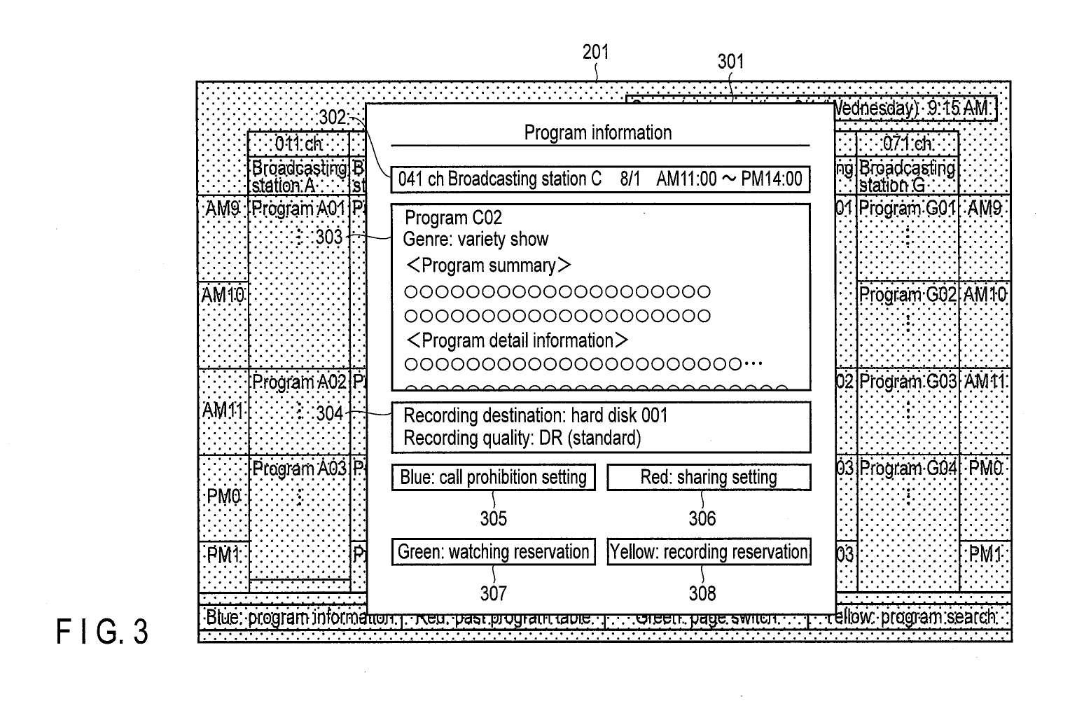

For example, when the decision key or the blue color key of the remote controller is selected while one program section is selected, the controller 150 displays by superimposing a window 301 for displaying the program information illustrated in FIG. 3 on the EPG screen 201.

The window 301 includes a display section 302 showing a channel name, a broadcasting-station name, and a broadcasting date. Furthermore, the window 301 includes a display section 303 showing a program title, a genre of a program, program summary, and program detail information.

In addition, the window 301 includes a display section 304 showing recording quality and recording destination when the program displayed in the display section 303 is recorded. Furthermore, the window 301 includes guiding indications 305 to 308. The guiding indications 305 to 308 indicate functions of color keys.

When the blue color key is selected, the guiding indication 305 is a guiding indication for presenting the notification that a call prohibition setting is set. When the red color key is selected, the guiding indication 306 is an indication for presenting the notification that a sharing setting is set. When a green color key is selected, the guiding indication 307 is an indication for presenting the notification that watching reservation is set. When a yellow color key is selected, the guiding indication 308 is an indication for presenting the notification that recording reservation is set.

When the green color key is selected, the controller 150 sets the watching reservation of a program displayed in the display section 303. Thus, when receiving a stream of the program displayed in the display section 303 by the broadcast signal, the broadcast receiving device 100 automatically selects the program.

When the yellow color key is selected, the controller 150 sets the recording reservation of the program displayed in the display section 303. Thus, when receiving the stream of the program displayed in the display section 303 by the broadcast signal, the broadcast receiving device 100 automatically records the program.

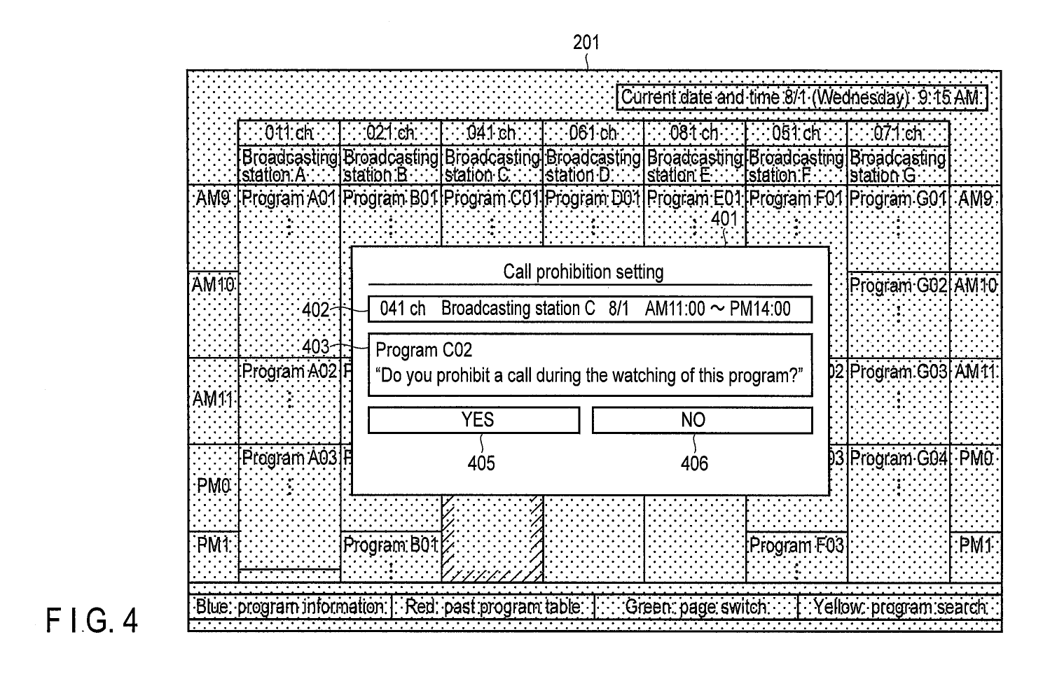

When the blue color key being displayed in the window 301 illustrated in FIG. 3 is selected, the controller 150 displays by superimposing a window 401 for setting the call prohibition setting at the time of watching the program displayed in the display section 303 illustrated in FIG. 4 on the EPG screen 201.

The window 401 includes a display section 402 showing a channel name, a broadcasting-station name, and a broadcasting date. In addition, the window 401 includes a display section 403 showing a program title and guiding indications. The controller 150 displays a guiding indication that “Do you prohibit a call during the watching of this program?” on the display section 403. Further, the window 401 includes a YES button 405 and a NO button 406.

When the YES button 405 is selected, the controller 150 sets the call prohibition setting in order to turn off the voice call function during the displaying of the program displayed in the display section 403. That is, the controller 150 serves as a setting module setting a program at which the voice call function is turned off. The controller 150 stores the call prohibition setting in, for example, the non-volatile memory 154. In addition, when the NO button 406 is selected, the controller 150 closes the window 401 without setting the call prohibition setting.

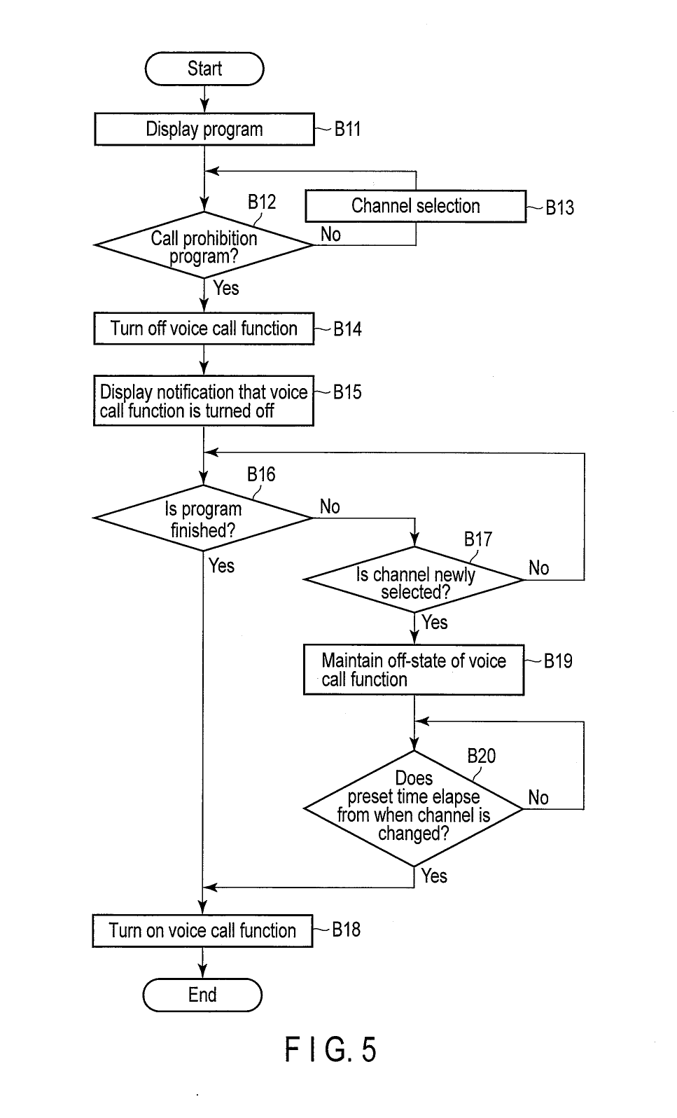

FIG. 5 illustrates an example of a process of the broadcast receiving device 100 when the call prohibition setting is set.

The controller 150 of the broadcast receiving device 100 displays a video of a program on the display 134 of the broadcast receiving device 100 in response to the channel selection of the program and the turning on of the broadcast receiving device 100 (Block B11), etc. More specifically, the controller 150 receives the broadcast signal, and selects the channel of a program. Then, the controller 150 reproduces a stream of the program of the selected channel, and displays the reproduced stream of the program on the display 134.

In addition, the controller 150 refers to the call prohibition setting. The controller 150 determines whether or not the program being watched is a call prohibited program based on the call prohibition setting (Block B12). That is, the controller 150 determines whether or not the program being displayed is set as a program at which the voice call function is turned off.

When it is determined that the program being watched is not the call prohibited program, the controller 150 continues to output the program. When a program is selected by a channel selection input in Block B13, the controller 150 proceeds to Block B12, and determines whether or not the selected program is the call prohibited program.

When it is determined that the program being watched is the call prohibited program, the controller 150 turns off the voice call function of the broadcast receiving device 100 (Block B14). For example, the controller 150 turns off the voice call function by stopping the application software of the voice call function or by logging out of the authenticated server. The controller 150 maintains an off-state of the voice call function until the call prohibited program finishes.

The controller 150 controls the OSD processor 132 to display the notification that the voice call function is turned off on the display 134 (Block B15). Thus, since the call prohibited program is selected, the broadcast receiving device 100 can inform the user of the notification that the voice call function is turned off.

The controller 150 successively determines whether or not the selected program finishes (Block B16). Further, the controller 150 successively determines whether or not a new channel selection is input (Block B17).

When it is determined that the currently selected program (that is, the call prohibited program) finishes (Yes at Block B16), the controller 150 turns on the voice call function (Block B18). For example, by resuming the application software of the voice call function or by logging in the authenticated server, the controller 150 turns on the voice call function.

If it is determined that a new channel selection is input (Yes at Block B17), the controller 150 maintains the off-state of the voice call function (Block B19). That is, even if the channel is changed to alter the current call prohibited program to another program, the controller 150 maintains the off-state of the voice call function. Then, the controller 150 counts an elapsed time from when the channel is changed.

The controller 150 successively determines whether or not the elapsed time from when the channel is changed reaches a preset time (Block B20). When it is determined that the elapsed time from when the channel is changed reaches the preset time, the controller 150 proceeds to Block B18, and turns on the voice call function.

If the program of the channel selected at Block B17 is not a call prohibited program, the controller 150 may proceed to Block B16 without counting the elapsed time from when the channel is changed.

In other words, according to the process described above, if the program being watched is not a call prohibited program even at the broadcasting time of the call prohibited program, the controller 150 does not turn off the voice call function. As described with reference to Blocks B12 and B13, when the program being watched (that is, the program of the selected channel) is the call prohibited program, the controller 150 turns off the voice call function.

As described above, the controller 150 sets in advance the call prohibited program at which the voice call function is invalidated, and turns off the voice call function at the time of watching the set call prohibited program. Accordingly, it is possible to prevent the broadcast receiving device 100 from receiving the voice call from the outside while the user watches a specific program. As a result, it is possible to provide an electronic device offering high convenience and a control method of the electronic device.

In addition, even when the channel is changed to select another program other than the call prohibited program after the voice call function is turned off, the controller 150 can maintain the off-state of the voice call function for a preset time. Thus, the controller 150 can prevent the off-state of the voice call function from being released due to instant temporary channel changes.

Further, the broadcast receiving device 100 may release the off-state of the voice call function, namely, turn off the voice call function in response to a predetermined operation at the time of watching the call prohibited program. For example, the controller 150 may release the off-state of the voice call function based on a signal corresponding to a predetermined button of the remote controller 163 or an operation from a quick menu.

Moreover, the broadcast receiving device 100 may turn off the voice call function in response to a predetermined operation at the time of watching a program other than the call prohibited program. For example, the controller 150 may set the program being watched as the call prohibited program based on the signal corresponding to the predetermined button of the remote controller 163 or the operation from the quick menu.

Furthermore, as described above, the controller 150 can simultaneously record programs of a plurality of channels in the storage 172. The controller 150 can generate a past program table by using a list of programs recorded in the storage 172. The past program table is a program table simultaneously generated by associating the recorded programs recorded in the storage 172 with the broadcasting dates, similarly to the EPG. The broadcast receiving device 100 can reproduce the recorded program in response to the operation of the past program table.

When a program is selected from the past program table at the time of watching the call prohibited program, namely, when an operation is input to reproduce the program recorded in the storage 172, the broadcast receiving device 100 may release the off-state of the voice call function.

In addition, the controller 150 may set the call prohibited program from the past program table. When the program section is selected in the past program table, the controller 150 displays the same window as the window 301 illustrated in FIG. 3. Information indicating the storage 172 in which the selected program is recorded is displayed in the display section 304. In addition, when the green color key is selected, the notification that the program is stored (the program is protected so as not to release the program) is displayed as the guiding indication 307. Moreover, when the yellow color key is selected, the notification that the selected program is reproduced is displayed as the guiding indication 308.

When a blue color key is selected while the window 301 displayed by the operation of the past program table is displayed, the controller 150 sets the program displayed in the display section 303 as the call prohibited program at the time of watching the program. Further, the controller 150 may set the same program as the program displayed in the display section 303, which is a program to be broadcasted, as the call prohibited program.

In addition, the controller 150 may store the program set as the call prohibited program as a history. For example, when the program set as the call prohibited program has been set as the call prohibited program in the past, the controller 150 may cause the user to select whether to set as the call prohibited program.

Furthermore, the controller 150 may set a plurality of programs as the call prohibited program based on the genre of the program. The program information for creating the EPG includes information indicating the genre of the program. The controller 150 sets the genre of the program (call prohibited genre) registered as the call prohibited program in response to the input of the user. When the selected program is the program corresponding to the genre registered as the call prohibited genre, the controller 150 turns off the voice call function.

Moreover, the controller 150 may set to turn on or off the voice call function for the channel. For example, the controller 150 sets the channel (call prohibited channel) at which the voice call function is turned off in response to the input of the user. When the selected channel is the call prohibited channel, the controller 150 turns off the voice call function.

In addition, the controller 150 may set the program, genre, or channel at which the voice call function is stopped by using information already set in the broadcast receiving device 100. For example, when a favorite channel is already set, the controller 150 may automatically set the favorite channel as the call prohibited channel.

In addition, the aforementioned embodiment has been described that when the selected program is the call prohibited program, the controller 150 turns off the voice call function. However, the present embodiment is not limited to such a configuration. The controller 150 may turn off the voice call function within a preset period of time before or after the program, set as the call prohibited program, starts to reproduce.

For example, the controller 150 can recognize the time until the program set as the call prohibited program starts to reproduce based on the program information. For example, when the time until the program set as the call prohibited program starts to reproduce is less than a preset time, the controller 150 may turn off the voice call function. Further, the controller 150 may simultaneously turn off the voice call function when the program set as the call prohibited program starts to reproduce.

In addition, the controller 150 can recognize the elapsed time from when the program set as the call prohibited program starts to reproduce based on the program information. By counting the time from when the program actually starts to reproduce, the controller 150 can recognize the elapsed time from when the program set as the call prohibited program starts to reproduce. When the elapsed time from when the program set as the call prohibited program starts to reproduce is more than or equal to a preset time, the controller 150 may turn off the voice call function. The controller 150 may simultaneously turn off the voice call function when the program set as the call prohibited program starts to reproduce.

A sharing setting will be described below.

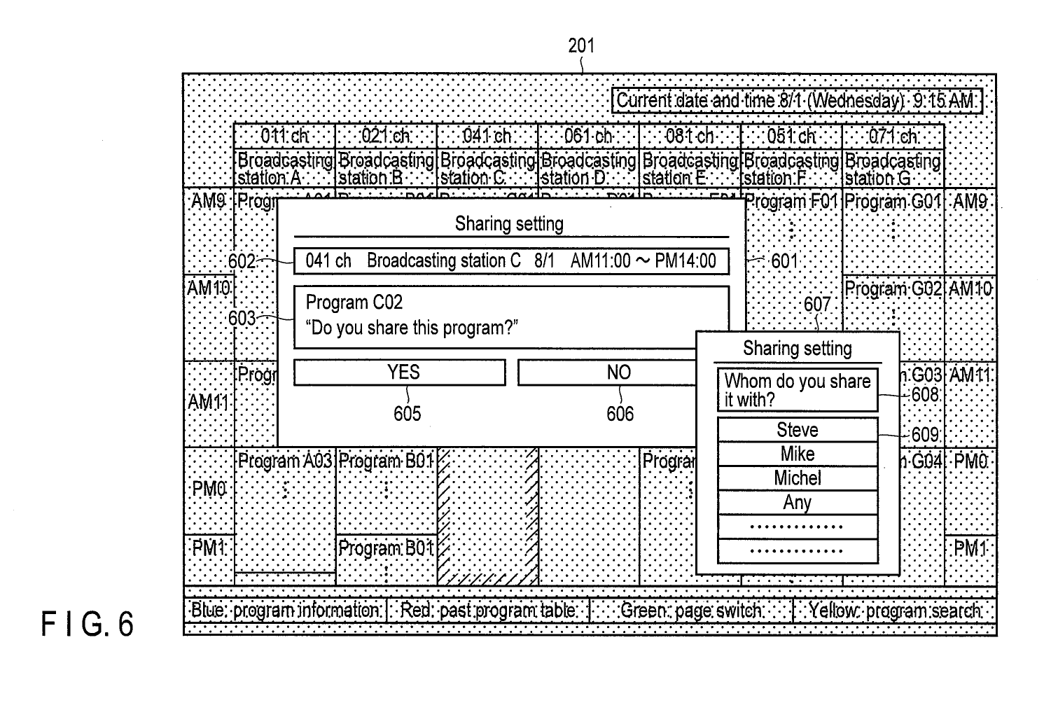

When the red color key during the display of the window 301 illustrated in FIG. 3 is selected, the controller 150 displays a window 601 superimposed on the EPG screen 201 as illustrated in FIG. 6. The window 601 is provided to set the sharing setting for sharing the program at the time of watching the program displayed in the display section 303.

The window 601 includes a display section 602 showing a channel name, a broadcasting-station name, and a broadcasting date/time. Furthermore, the window 601 includes a display section 603 showing a program title and guiding indications. The controller 150 displays a guiding indication that “do you share this program?” in the display section 603. Further, the window 601 includes a YES button 605 and a NO button 606.

When the YES button 605 is selected, the controller 150 sets to make a voice call to another user connected via the network by the voice call function at the time of watching the program displayed in the display section 603. That is, the controller 150 sets the program displayed in the display section 603 as the sharing program. To achieve this, the controller 150 displays a window 607 for setting a called party of the voice call.

The window 607 includes a display section 608 displaying a guiding indication and a list of users 609 capable of being contacted by the voice call function. The controller 150 displays the guiding indication that “whom do you share it with?” in the display section 608. The controller 150 sets to make the voice call to the user selected in the list 609.

In the above-described setting, the controller 150 determines whether or not the selected program is the program set as the sharing program.

When it is determines that the selected program is the program set as the sharing program, the controller 150 makes a voice call to a called party previously selected by the user by the voice call function. Thus, when the program previously set as the sharing program starts to be watched, the broadcast receiving device 100 can start the voice call with the called party set in advance.

By doing this, the broadcast receiving device 100 can improve user's convenience of enjoying a predetermined program while the user talks with anyone. In addition, even when the login for the voice call function and the operation of starting a call are not performed, the broadcast receiving device 100 can automatically start the voice call.

When the broadcast receiving device 100 includes a plurality of applications for performing the voice call, the controller 150 may cause the user to select the application. For example, the controller 150 may display the list of applications of the voice call on the window 607. The controller 150 uses the application selected by the input from among the applications displayed on the list, for the voice call.

In addition, when the red color key is selected during the display of the window 301 displayed by the operation in the past program table, the controller 150 may display windows 601 and 607 illustrated in FIG. 6. Thus, the controller 150 can set the sharing program even from the past program table. Moreover, the controller 150 may set the same program as the program displayed in the display section 303, which is the program to be broadcasted.

Further, the controller 150 may store the program set as the sharing program as the history. For example, when the program set as the sharing program has been set as the sharing program in the past, the controller 150 may cause the user to select whether to continuously set the program as the sharing program.

In addition, the controller 150 may add icons to the call prohibited program and the sharing program on the EPG.

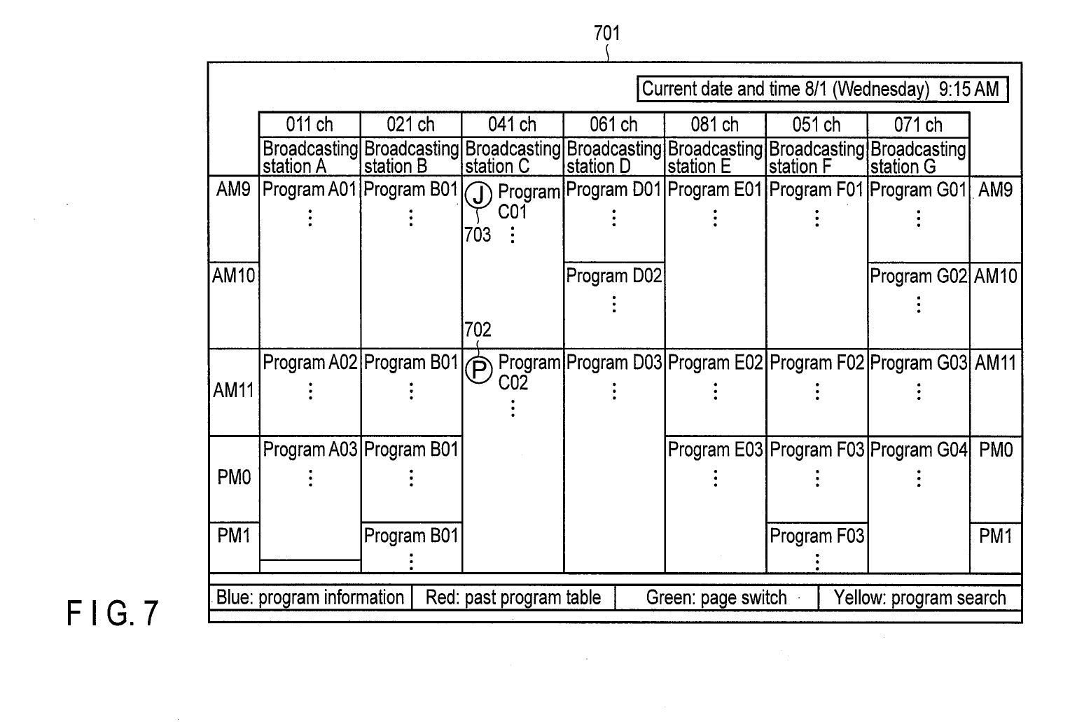

FIG. 7 illustrates an example of an EPG screen 701 when the call prohibited program and the sharing program are set. FIG. 7 illustrates an example where “program 002” of “041ch” is set as the call prohibited program, and “program 001” of “041ch” is set as the sharing program.

The controller 150 displays an icon 702 in the program section of the program set as the call prohibited program. In addition, the controller 150 displays an icon 703 in the program section of the program set as the sharing program. Thus, the broadcast receiving device 100 can cause the user to recognize the program set as the call prohibited program and the program set as the sharing program on the EPG screen.

In addition, the broadcast receiving device 100 may turn off the voice call function at the preset time.

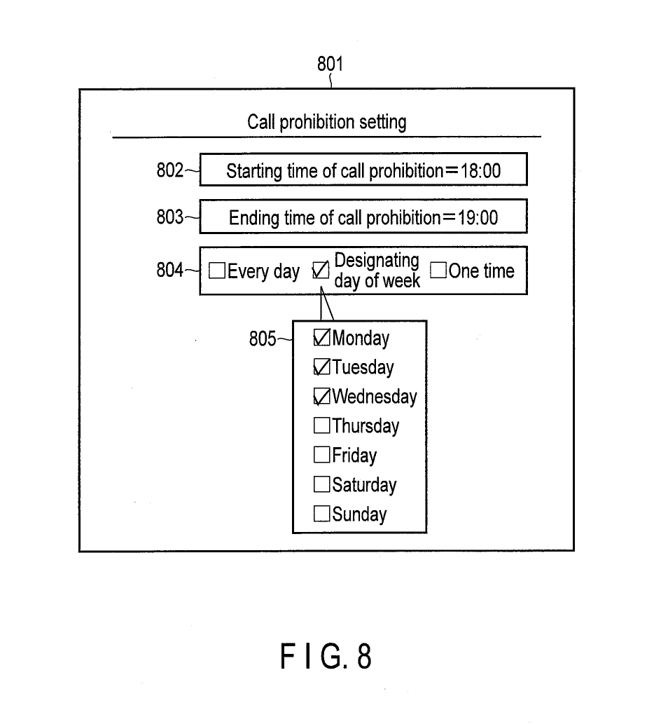

FIG. 8 illustrates an example of a window for setting a time to turn off the voice call function. When an operation for setting a time to turn off the voice call function in a quick menu, a typical setting menu, or a menu of setting the application of the voice call function is input, the controller 150 displays a window 801.

The window 801 includes an input section 802 for setting a time to turn off the voice call function, namely, a time to start to prohibit the voice call. In addition, the window 801 includes an input section 803 for setting a time to switch to the on-state of the voice call function from the off-state thereof, namely, a time to release the prohibition of the voice call.

The controller 150 sets a time to turn off the voice call function and a time to turn on the voice call function based on the input sections 802 and 803. When the controller 150 switches the on-state or the off-state of the voice call function based on the setting. That is, when it is determined that a current time becomes the time to turn off the voice call function, the controller 150 turns off the voice call function. In addition, when it is determined that the current time becomes the time to turn on the voice call function, the controller 150 turns on the voice call function.

In addition, the window 801 includes a menu 804 for setting whether to repeatedly control the on-state or the off-state of the voice call function in the setting of the above-described time. The content of the menu is, for example, “every day,” “one time,” and “day of week.” That is, the controller 150 can set the time to prohibit the voice call by designating only one time, every day, or day of week.

For example, when “every day” is selected in the menu 804, the controller 150 switches the on-state or the off-state of the voice call function every day based on the times input in the input sections 802 and 803. For example, when “one time” is selected in the menu 804, the controller 150 switches the on-state or the off-state of the voice call function only one time based on the times input in the input sections 802 and 803.

In addition, when “day of week” is selected in the menu 804, the controller 150 displays the list 805 representing the day of week in the window 801. Thus, the controller 150 can cause the user to designate the day of week for prohibiting the voice call. When “day of week” is selected in the menu 804, the controller 150 switches the on-state or the off-state of the voice call function only the day of week designated in the list 805 based on the times input in the input sections 802 and 803.

In such a configuration described above, the broadcast receiving device 100 can set the time to prohibit the voice call in response to the intent of the user. Thus, the broadcast receiving device 100 can prevent from receiving the voice call at the time not intended by the user.

In addition, the broadcast receiving device 100 may turn on the voice call function at only the preset time. In this case, the controller 150 displays the same window as that in FIG. 8. In this case, the window 801 includes an input section for setting a time to turn on the voice call function, namely, a time to release the off-state of the voice call. In addition, the window 801 includes an input section for setting the time to switch the on-state or the off-state of the voice call function, namely, the time to start to prohibit the voice call.

The controller 150 sets the time to turn on the voice call function and the time to turn off the voice call function based on the times input in the input sections.

In such a configuration described above, the broadcast receiving device 100 can set the time to prohibit the voice call in response to the intent of the user. Thus, the broadcast receiving device 100 can prevent from receiving the voice call at the time not intended by the user.

In addition, the broadcast receiving device 100 may automatically start the voice call at the preset time.

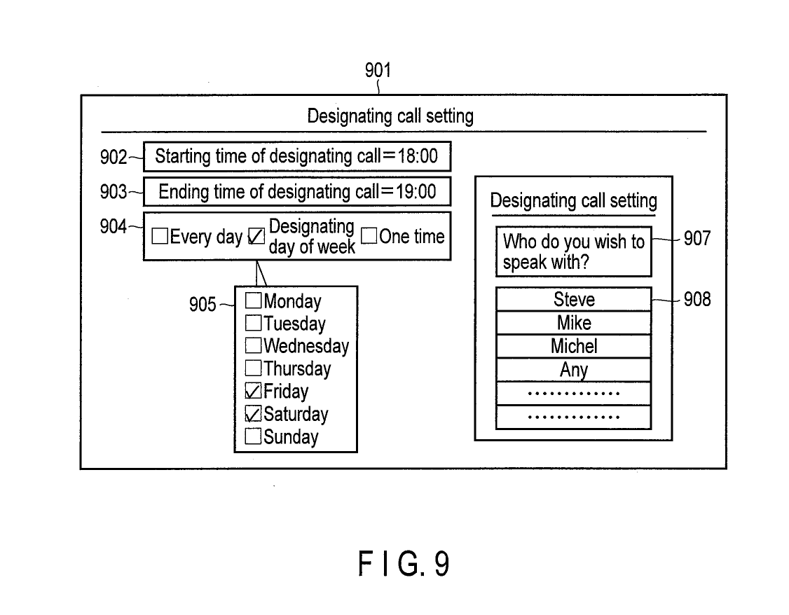

FIG. 9 illustrates an example of a window for setting a time to automatically start the voice call. When an operation for setting a time to automatically start a voice call in a quick menu, a typical setting menu or a menu of setting the application of the voice call function is input, the controller 150 displays a window 901.

The window 901 includes an input section 902 for setting a time to automatically start the voice call. In addition, the window 901 includes an input section 903 for setting a time to automatically end the voice call. The controller 150 automatically makes the voice call based on the times input in the input sections 902 and 903.

Further, the window 901 includes a menu 904 for setting whether to repeatedly make the voice call in the setting of the time. The content of the menu includes, for example, “every day,” “one time,” and “day of week.” That is, the controller 150 can set the time to make the voice call by designating only one time, every day, or day of week.

In addition, the window 901 includes a display section 907 indicating a guiding indication and a list of users 908 capable of being contacted by the voice call function. The controller 150 displays the guiding indication that “Whom do you talk with?” on the display section 907. The controller 150 set to make the voice call to the user selected in the list 908.

For example, when “every day” is selected in the menu 904, the controller 150 makes the voice call to the user selected in the list 908 every day based on the times input in the input sections 902 and 903. In addition, for example, when “one time” is selected in the menu 904, the controller 150 makes the voice call to the user selected in the list 908 only one time based on the times input in the input sections 902 and 903.

In addition, when “day of week” is selected in the menu 904, the controller 150 displays a list 905 representing days of week in the window 901. Thus, the controller 150 can cause the user to designate the day of week to make the voice call. When “day of week” is selected in the menu 904, the controller 150 makes the voice call to the user selected in the list 908 only the day of week designated in the list 905 based on the times input in the input sections 902 and 903.

In such a configuration described above, the broadcast receiving device 100 can make the voice call to the called party set in advance at the time in response to the intent of the user. Thus, the user can periodically perform the voice call with the preset called party at the preset time by the broadcast receiving device 100.

The functions described in the above-mentioned embodiments is not limited to such a configuration using hardware, but may be implemented by reading programs in which the functions are described by software by a computer. In addition, the functions may be implemented by appropriately selecting either software or hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising a voice call function to perform a voice call with an external device via a network, the electronic device comprising:
a reproducer configured to receive a broadcast signal to reproduce a program contained in the broadcast signal; and
a controller configured to turn off the voice call function within a preset period of time, the preset period of time covering a time when the reproducer starts to reproduce a preset program.

2. The device of claim 1, wherein the controller is configured to set a program at which the voice call function is turned off based on a given input.

3. The device of claim 2, wherein
the reproducer is configured to select a channel from the broadcast signal in response to a channel selection, and
the controller is configured to maintain an off-state of the voice call function for a preset time when the channel is selected.

4. The device of claim 2, wherein the controller is configured to release an off-state of the voice call function when a preset signal is input.

5. The device of claim 2, wherein the controller is configured to set a plurality of programs corresponding to a genre designated by the input as a program at which the voice call function is turned off.

6. The device of claim 2, wherein the controller is configured to set a plurality of programs corresponding to a channel designated by the input as a program at which the voice call function is turned off.

7. The device of claim 1, further comprising:
a control module configured to make a voice call to an external device set in advance by the voice call function when the preset program is reproduced by the reproducer.

8. The device of claim 1, further comprising:
a control module configured to turn off the voice call function at a preset time.

9. The device of claim 1, further comprising:
a control module configured to turn on the voice call function at a preset time.

10. The device of claim 1, further comprising:
a control module configured to make a voice call to an external device set in advance by the voice call function at a preset time.

11. An electronic device comprising a voice call function to perform a voice call with an external device via a network, the device comprising:
a program information acquiring module configured to receive a broadcast signal and to acquire program information contained in the broadcast signal;
a screen generator configured to generate a screen of an electronic program table based on the program information; and
a setting module configured to set a program selected by an input on the screen of the electronic program table as a program at which the voice call function is turned off.

12. The device of claim 11, wherein the setting module is configured to set a plurality of programs corresponding to a genre designated by the input as a program at which the voice call function is turned off.

13. The device of claim 11, wherein the setting module is configured to set a plurality of programs corresponding to a channel designated by the input as a program at which the voice call function is turned off.

14. A method of controlling an electronic device comprising a voice call function to perform a voice call with an external device via a network, the method comprising:
receiving a broadcast signal to reproduce a program contained in the broadcast signal; and
turning off the voice call function when a preset program is reproduced.
